(19) United States
(12) Patent Application Publication
(10) Pub. No.: US 2008/0191184 A1
(43) Pub. Date: Aug. 14, 2008

(54) Lifting Device or Jack for a Vehicle

(76) Inventor: James Howard, Mirande (FR)

Correspondence Address: Vern Maine & Associates, 100 MAIN STREET, P O BOX 3445, NASHUA, NH, 03061-3445, US

(21) Appl. No.: 11/912,652

(22) PCT Filed: Apr. 26, 2006
(86) PCT No.: PCT/IB06/01014

§ 371 Date: Apr. 15, 2008

(30) Foreign Application Priority Data
Apr. 26, 2005 (FR) 0504270

(51) Int. Cl. B60S 9/02; B60S 9/00

(52) U.S. Cl. 254/427; 254/418

(57) ABSTRACT

The invention relates to a lifting appliance or a jack for vehicles preferably comprising axles or four drive wheels. Said lifting appliance mainly comprises a base to which an arm is connected in an articulated manner, said arm containing a height-adjustable rod having an upper end which is positioned beneath a vehicle body or an axle, in order to change a wheel, for example. The invention enables the above-mentioned disadvantages to be mitigated, in that the inventive appliance eliminates certain steps carried out to lift the vehicle or to fold up the arm of the jack once the wheel has been changed, especially the use of a crank for cranking up the jack. Said novel appliance requires only one manual operation, that is mainly to manually position the appliance beneath the vehicle, in the usual spot for said function.

The invention relates to a lifting device or jack for vehicles, preferably comprising axles or four drive wheels, which lifting device substantially comprises a base on which there is articulated an arm containing an adjustable-height rod, the upper end of the latter being positioned beneath a bodywork or an axle, in order to change a wheel, for example.

At present, many devices for lifting of vehicles at a given point beneath the bodywork or beneath an axle are known, in order to change a wheel of which the tyre is punctured, for example. These devices can be manual, hydraulic or electric, and are generally designed to occupy a reduced space once they have been folded. The manual devices often comprise a vertical rack which slides in a vertical tube which is supported on three feet, and the said rack is raised by the intervention of pinions which are activated by means of a crank. There also exist jacks which consist of associated arms forming rhombuses which extend on a vertical plane, and are deformed by the intervention of a shaft which is positioned diagonally on a horizontal plane, which shaft has two screw pitches in opposite directions, starting from the ends towards the centre, which drive the opposite angles through which the shaft passes, in inverse directions.

Generally, during a technical intervention on a vehicle, and after the jack has been placed beneath the vehicle, the use of one of these two known types of manual jacks requires a plurality of manual interventions by the operator. In fact, once the jack has been positioned beneath the vehicle, by means of a crank the operator must extend the jack slightly upwards as far as a point of contact with the vehicle, such as to stabilise the said jack on the ground, and then the operator must extend the jack significantly, and high enough, by means of the said crank, to lift the part of the vehicle which is close to the wheel to be changed.

A first disadvantage consists in the fact that four-wheel drive vehicles, and in particular off-road vehicles, as well as small utility vehicles, have a chassis which is extra high, which complicates the manoeuvre. The first two steps are more or less long, depending on the skill of the user, and the third step requires muscular effort, in a curved position or optionally with one knee on the ground. This muscular effort exerted by the arms in order to manoeuvre the crank, in a posture which is more or less comfortable, is unpopular with drivers, and the manoeuvre is often very difficult for people who are over the age of 60.

The invention which is the subject of the present application makes it possible to eliminate the aforementioned disadvantages, in that the device eliminates certain steps, and in particular the handling of a crank in order to extend the jack upwards, so as to lift the vehicle or fold back the jib of the jack, once the change of wheel has been completed. In fact, the use of this new device is summarised in a single manual operation, which consists mainly of positioning the said device manually beneath the vehicle, at the point habitually provided for this function. It is then the vehicle which, by means of a short forward or reverse movement, as appropriate, using the engine, will automatically raise the device, thus making it possible to lift the part of the chassis adjacent to the wheel to be replaced. Once the technical operation has been completed, the vehicle will automatically return the support arm of the device towards the horizontal position, by means of its forward or reverse displacement which is the inverse of the first movement, and the raised wheel will touch the ground once more.

The invention which is the subject of the present document, which makes it possible to eliminate the disadvantages previously described, comprises a base with a substantially flat rectangular form, which base consists of a frame, one end of which that is closed being able to receive an extension piece, and another end which is not closed and supports a perpendicular transverse shaft, on which there pivots the foot of a straight arm, which comprises on its upper part a means for supporting and adjusting the height of a straight rod which is accommodated in the said straight arm, which rod is provided with a head, and slides towards the top end of the said support arm, so as to obtain sufficient projection of the latter, such that the height of the arm plus the projecting part of the rod is greater than the height of the chassis in relation to the ground, in order to lift the chassis when the support arm is rotated.

Once the technical intervention on the vehicle has been completed, in order to fold back the device, the rod is released, then slides naturally by means of its weight towards the base of the support arm, and only the head of its top end extends from the support arm, via a transverse curved part which is supported by means of its lower surface on the said top end of the said arm.

Since the support arm is designed to be stored in the base, it has an appropriate length which is less than that of the base, such that the said additional length of the head of the rod which extends from the upper part of the arm can, by means of its pivoting rearwards, occupy the free space between the two longitudinal sides of the base. The stored arm is locked in the base by means of a transverse rod at the level of the head of the rod.

According to a variant design, the straight rod which slides in the support arm is a straight rack, comprising a serration on its front part and along its entire height. The support arm has a rectangular transverse cross-section, and on its upper part it comprises a front opening, in which opening there moves a ratchet opposite the serration of the rack. The ratchet pivots by means of a shaft which is supported by an added-on part, on both sides, on the support arm and adjacent to the front opening.

The base with a substantially rectangular form consists of a frame formed with profiles in the form of a “U” lying on their side, and oriented towards the exterior around the entire periphery of the said base. On the front end of the base, an extension piece is positioned by means of its two longitudinal sides which slide on the longitudinal sides of the base, so as to provide the base with greater stability on certain types of ground.

The rack is accommodated in the support arm, and its upper end comprises a curved head which is suitable for receiving and hooking on to a point of the chassis or axle to be lifted. The curved head has dimensions which are advantageous for being retained at the top end on the exterior of the support arm. The length of the part of the rack which projects relative to the support arm is previously adjusted manually, according to the height of the chassis of the vehicle, such that, when the device is positioned beneath the vehicle, in the longitudinal direction of the latter, the angle formed by the support arm is equal to approximately 45° relative to the chassis of the vehicle. When this prior adjustment has been completed, the head of the rack is placed or hooked beneath the point of the vehicle to be lifted. Placing of the top end of the rack beneath the vehicle positions the support arm on an inclined plane, and the base of the device is supported on the ground, offset relative to the top point of the rack.

A small forward or reverse movement of the vehicle, depending on whether the base is placed towards the front or rear of the vehicle, relative to the top point of the rack, raises the support arm upwards to the vertical position, on the base, thus lifting the wheel from the ground.

The shaft which passes through the foot of the support arm on which the said support arm pivots is eccentric rearwards relative to the longitudinal and median axis of the said support arm, such that, during the pivoting of the support arm from a standby position beneath the vehicle, to a raised position, the rear edges of the base of its foot do not stop the movement when they strike hard ground. In addition, the eccentric position rearwards of the shaft which supports the support arm assures, during the rotation of the said arm, when the latter reaches the vertical position, the continuation of the movement as far as the end-of-travel against a transverse stop, taking into account the fact that the descent of the load tends to give rise to continuation of the rotation of the support arm forwards, beyond the vertical position. However, this continuation of rotation of the arm forwards, beyond the vertical position, is stopped immediately by the transverse stop which is secured to the upper part of the base. This eccentric position provides a directional trend forwards of the support arm, in the vertical position, thus stabilising its raised position against the stop placed in front of its front surface.

According to another characteristic of the invention, the device is provided at the base of the foot of the support arm of the rack with an audible alarm, either by means of a spring plate or an electric alarm which uses a battery, such as to indicate to the driver the end-of-travel of the rotation of the said support arm, when the latter reaches the vertical position. The audible alarm is installed and programmed such that the alarm bell goes off slightly before the support arm reaches the vertical position, so that the driver has time to react on the brake of the vehicle, before the end-of-travel is reached. This alarm bell is shrill enough to be perceived by the driver, despite the noise of the engine which is running in order to impart the necessary movement to the vehicle.

According to another simplified variant embodiment of the device, the rod which slides in the support arm consists of a tube which has a form similar to the support arm, and has a slightly smaller cross-section in order to allow the rod to slide. The support arm and the tube comprise transverse opposite apertures, which permit adjustment by means of a rod and a pin.

Other characteristics and advantages of the invention will become apparent from reading the following description of a preferred embodiment, provided by way of non-limiting example with reference to the attached drawings.

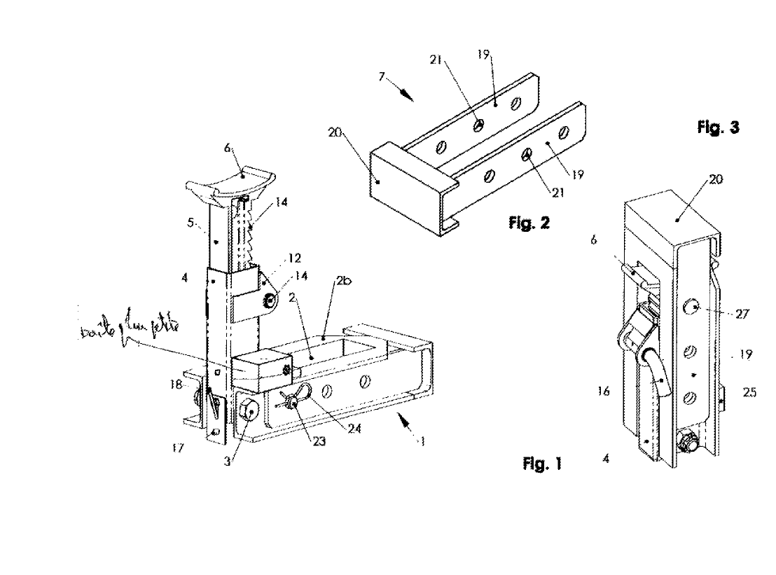

FIG. 1 shows in perspective and from the rear a device of which the support arm is in the vertical position;

FIG. 2 shows in perspective the extension piece of the base;

FIG. 3 shows in perspective a device which is fully folded back on itself;

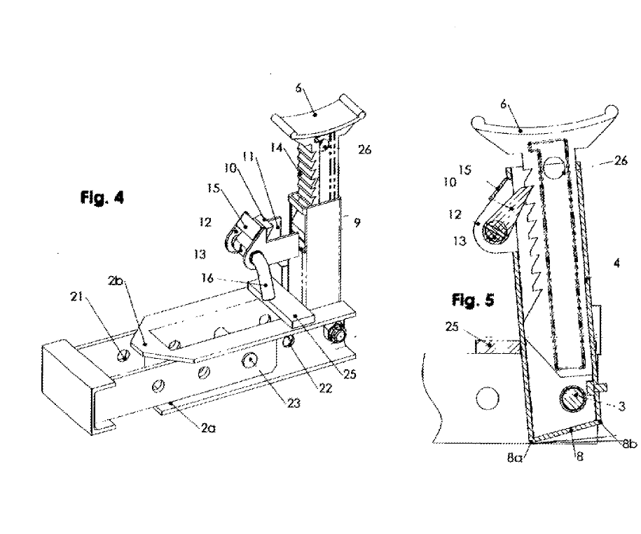

FIG. 4 shows in perspective the support arm partially in exploded view and an extension piece partly extended;

FIG. 5 shows a vertical cross-section of the support arm at the end-of-travel;

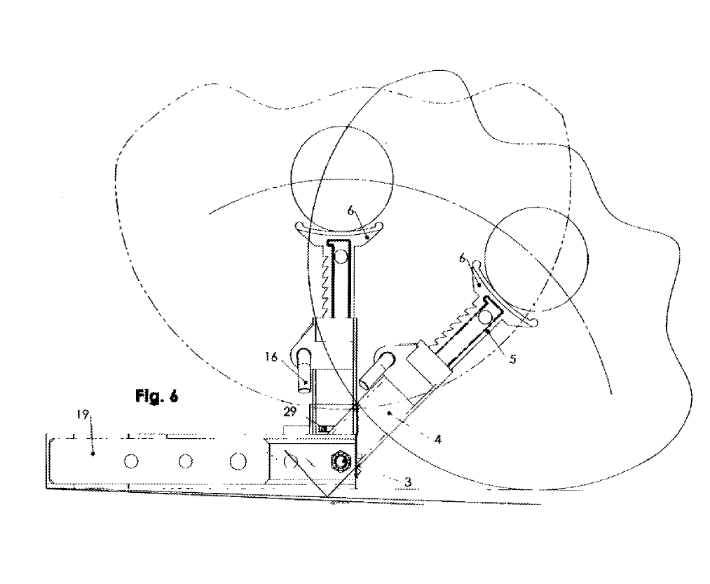

FIG. 6 shows the oblique starting position beneath the vehicle and the raised position of the rack support arm;

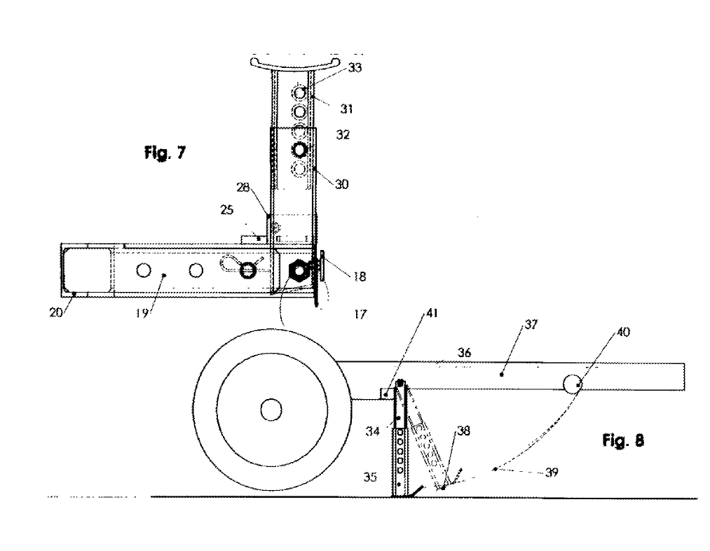

FIG. 7 shows a simplified variant of the design of the support arm; and

FIG. 8 shows a simplified design of the support arm, secured to the vehicle.

FIGS. 1 to 6 illustrate a device according to the invention, for lifting of vehicles, comprising a base 1 consisting of a substantially rectangular frame 2, one end of which is not closed, which non-closed end that constitutes the rear part of the base 1 has a shaft 3 passing through it, on which there pivots the foot of a support arm 4 which is equipped on the upper part with an articulated adjustment means in order to adjust and retain a straight rack 5, which rack is accommodated in the said support arm 4 and projects by means of its head 6 onto the upper end of the said support arm 4.

The frame 2 of the base 1 of the device consists of profiles in the form of a “U” lying down towards the exterior on three sides, on which cheeks an extension piece 7 is positioned via the front end of the said base. The bottom of the front end 2a of the base has a rectangular periphery formed by the cheeks of the “U”s 2b and the upper part 2b corresponding to a bevelled cut-out in the “U”s. The foot of the support arm is placed to the rear of the base 1, between the sides of the frame 2. The shaft 3 passes through the foot of the support arm perpendicularly on a horizontal plane, and in a manner which is eccentric towards the rear, such as to provide an end-of-travel of the support arm towards the front of the base. The foot of the support arm 4 is fitted on the shaft 3 at an appropriate distance from its base, and the said foot ends in a bevelled base wall 8, such that the front edge 8a is lower than the rear edge 8b, relative to the vertical walls of the support arm. This inclination of the base wall 8 forwards firstly makes it possible to avoid striking the rear edge 8b on the ground during the manoeuvre, and secondly ensures that in a substantially vertical position at the end-of-travel, the said foot has the front edge 8a of its base in contact with the ground.

The support arm 4 consists of a tube with a rectangular cross-section, and comprises a front opening 9 in the upper part along its entire length, via which opening there is articulated a ratchet 10 which is fitted on a support element secured to the walls of the arm. This support element consists of two cheeks 11 which are juxtaposed on the exterior on both sides, against the lateral side of the support arm, and are rendered integral with the sides of the support arm by being welded. The cheeks 11 are adjacent to the opening 9 and extend beyond the front part by means of parallel projections 12 which support the ends of a rotary shaft 13, on which shaft the ratchet 10 is secured opposite a front serration 14 of the rack 5. The two projections 12 are connected in the upper part by a transverse rod 15 which maintains the end of the ratchet close to the serration. The ratchet 10 is manoeuvred by means of its shaft 13, which extends on both sides of the projections 12 of the cheeks, and forms engagement bends 16 for manoeuvring of the said ratchet.

The foot of the support arm 4 comprises a removable articulated brake on its rear surface, which brake can be used to operate on grounds on which there are risks of skidding of the base of the device, such as, for example, on terrains which are too loose. This brake consists of a longitudinal stop plate 17, the width of which is smaller than the width of the rear wall of the support arm. The stop plate 17 is positioned via one end against the rear wall of the support arm and on a stud which is integral with the said rear surface of the arm, and is retained by means of a clamping key 18. For use of the brake, the longest part of the stop plate 17 is oriented towards the bottom of the base, by means of the clamping key 18, such that the part which extends beyond the bottom of the base abuts the ground and prevents possible slippage of the base.

An extension piece 7 is provided on the front of the base (FIG. 2), comprising two parallel longitudinal arms 19 consisting of flat rods which are joined at their front ends by a profile 20 in the form of a “U” lying on its side, the cheeks of which are oriented towards the front ends of the arms. The front ends of the arms 19 are rendered integral by means of their narrow edges, on the interior of the profiles 20. This extension 7 slides by means of the narrow edges of its two longitudinal arms 19 on the inner surfaces of the lower cheeks of the two longitudinal sides of the frame 2.

The arms 19 of the extension piece 2 of the base comprise respectively apertures 21 and 22 situated opposite and along the length, which, after the length of the extension piece on the base has been adjusted, make it possible to immobilise the arms 19 on the cheeks of the frame 2 by means of a rod 23 which is placed transversely to the base by means of apertures and a pin 24. The securing of the arms 19 to the frame 2 of the base makes it possible to prevent deformation of the said extension piece by spacing of the arms under strong pressure.

The rack 5 is straight and supports on its front surface the serration 14, and its top end supports an element known as the rack head 6, formed by a longitudinal part curved towards its centre. The two ends of the head 6 of the rack are raised sufficiently far to seize the point to be lifted of the vehicle. On the lower part, the rack 5 has on the surface of the serration a protuberance 5a, which advances against the inner wall of the front surface of the support arm 4. This protuberance maintains the rack parallel to the walls of the support arm, irrespective of its position.

During the manoeuvre, the support arm 4 pivots as far as the vertical position (FIG. 6), then its course is stopped by a transverse stop 25 which is rendered integral by any appropriate means on the cheeks of the frame 2 of the base. The stop 25 is positioned slightly recessed from the front, relative to the vertical position of the support arm, such that at the end-of-travel against the said stop, the arm has substantially inclination forwards, such as to stabilise its high position.

The rack 5 comprises below its head a transverse aperture 26 which corresponds, when the said rack is completely folded back into the frame of the base, to the transverse apertures in the front of the base and in the extension piece 7, such as to lock the rack in the base 1 together with the extension piece 7, by means of a transverse rod 27 and a pin.

An audible alarm is installed on one cheek at the rear part of the base, and adjacent to the stop 25, comprising a case 28 which contains an alarm bell powered by a battery. The alarm bell comprises a trolley contact 29 which is adjacent to the rotation of the support arm, such that, during its movement upwards, the latter touches the said trolley contact slightly before the vertical position, and triggers the alarm bell.

According to a simplified embodiment of the support arm of the device, shown in FIG. 7, the rack and its locking means positioned on the support arm 4 are replaced by a support arm 30 which is straight with a rectangular cross-section in which support arm there slides a second tube 31 with a similar form, the upper end of which supports a curved part which forms a head in order to seize the element of the vehicle to be lifted. The support arm 30 and the inner tube 31 comprise apertures 32 and 33 along their entire height, and in a transverse manner, such that, by means of coaxial displacement of the arm and the tube relative to one another, in the longitudinal direction, this movement makes it possible to make opposite apertures coincide, according to the desired height. Once the height has been adjusted, the position is locked by means of a transverse rod placed in a succession of corresponding apertures 32 and 33, and a rapid positioning pin. The support arm 30 is then placed below the vehicle, then raised on the base of the device, and functions as previously described.

According to another preferred embodiment of the invention, the device which is the subject of the present document is left permanently beneath the chassis of the vehicle (FIG. 8). For this purpose, a support arm 34 contains an inner tube 35, the upper end of which is secured permanently by means of a rotary fastener 36 to the bodywork 37 of the vehicle. In this case, the base I is replaced at the bottom of the support arm 34 by a plate 38 which projects from the periphery of the foot. The plate 38 is connected to the chassis by means of a cable 39. The foot of the support arm 34 is manoeuvred by means of the cable 39 which is wound onto a winding device 40 secured to the chassis, which winding device 40 is activated by any known means from the seat of the driver of the vehicle. In order to position the support arm 34 on the ground, according to this variant the winding device is disengaged, and allows the cable 39 to run, thus permitting descent of the foot of the support arm to the ground. Since the length of the arm has previously been adjusted, the support arm 34 is immediately in the operational position for a manoeuvre to be begun with the vehicle engine, in order to bring the said support arm into the vertical position. The rotary fastener 36 of the upper end of the inner tube is secured to the chassis in the vicinity of a vertical stop 41, in order to stop the pivoting of the arm in a substantially vertical position. When the intervention is completed, the arm is raised automatically against the chassis, by means of the winding device.

1. Lifting device or jack for vehicles, preferably comprising axles or four drive wheels, characterised in that the device comprises a base (1) consisting of a frame (2) with a substantially flat rectangular form, which base has a closed front end which can receive an extension piece (7), and an end which is not closed, which non-closed end supports a perpendicular transverse shaft (3), on which there pivots the foot of a longitudinal support arm (4) with a rectangular cross-section, which support arm or foot comprises a brake which is articulated on its rear surface, and the said support arm comprises on its upper part a means for supporting and adjusting the height of a straight rod which is accommodated in the support arm (4), which rod slides towards the top end of the support arm (4), and the rod projects on the upper end of the arm by means of a head (6), which rod consists of a straight rack (5) comprising a serration (14) on its front part, or it consists of a sliding tube (31) provided with transverse apertures along its entire height, in that the base (1) supports a transverse stop (25) which is integral with the cheeks of the frame (2), and an audible alarm is installed on one cheek of the said base, adjacent to the stop (25), in that the support arm (4) pivots rearwards in order to occupy the free space between the two longitudinal sides of the base, and in that, according to a simplified embodiment of the device, a support arm (34) contains an inner tube (35), the upper end of which is secured permanently, by means of a rotary fastener (36) to the chassis (37) of the vehicle.

2. Device according to claim 1, characterised in that the shaft (3) passes through the foot of the support arm perpendicularly, and in a manner which is eccentric rearwards, relative to the median and longitudinal axis of the said support arm.

3. Device according to claims 1 and 2, characterised in that the foot of the support arm which is fitted onto the shaft (3), at an appropriate distance from its base, ends in a bevelled base wall (8), such that the front edge (8a) is lower than the rear edge (8b).

4. Device according to claim 1, characterised in that the support arm (4) with a rectangular cross-section comprises a front opening (9) in the upper part, in which there moves a ratchet (10) which is fitted on a support element (11), opposite the serration (14) of the rack.

5. Device according to claims 1 and 4, characterised in that the support element of the ratchet (10) consists of two cheeks (11) which are juxtaposed on the exterior, on both sides, against the lateral sides of the support arm, and are integral with the latter.

6. Device according to claims 1 and 5, characterised in that the cheeks adjacent to the opening (9) are extended beyond the front part by parallel projections (12) which support the ends of a rotary shaft (13) on which the ratchet (10) is secured.

7. Device according to claim 1, characterised in that the frame (2) of the base (1) consists of profiles in the form of a “U”, the cheeks of which are lying down towards the exterior on three sides.

8. Device according to claim 1, characterised in that the extension piece (7) provided on the front of the base comprises two parallel longitudinal arms (19) formed by flat rods, and which are joined at their front ends by means of a profile (20) in the form of a “U” which is lying down.

9. Device according to claims 1, 7 or 8, characterised in that the extension piece 7 slides by means of the narrow edges of its two longitudinal arms, on the inner surfaces of the lower cheeks of the two longitudinal sides of the frame (2).

10. Device according to claim 1, characterised in that the brake, on the rear surface of the foot, consists of a longitudinal stop plate (17) which is positioned via one end against the rear wall of the support arm, on a stud, by means of a clamping key.

11. Device according to claim 1, characterised in that the transverse stop (25) is positioned slightly recessed from the front, relative to the vertical position of the support arm (4), such that, at the end-of-travel, the support arm is inclined substantially to the front of the device.

12. Device according to claims 1 or 11, characterised in that the support arm (30) and the inner tube (31) comprise apertures (32) and (33) along their entire height and on their lateral surfaces, and in a transverse manner, which coincide with one another by means of coaxial displacement of the tube (31) in the support arm (30).

13. Device according to claim 1, characterised in that the storage of the support arm (4) plus the head (6) of the sliding rod is locked by means of a transverse rod at the level of the head of the rod.

14. Device according to claims 1 and 12, characterised in that the foot of the support arm (34) is manoeuvred by means of a cable (39) wound onto a winding device (40) which is secured to the chassis.
